(19) United States
(12) Patent Application Publication
(10) Pub. No.: US 2025/0042424 A1
(43) Pub. Date: Feb. 6, 2025

(54) AUGMENTED REALITY (AR) BASED OPTIMIZATION OF AGGREGATED POWER CONSUMPTION

(71) Applicant: INTERNATIONAL BUSINESS MACHINES CORPORATION, Armonk, NY (US)

(72) Inventors: Atul Mene, Morrisville, NC (US); Jeremy R. Fox, Georgetown, TX (US); Tushar Agrawal, West Fargo, ND (US); Sarbajit K. Rakshit, Kolkata (IN)

(21) Appl. No.: 18/363,070

(22) Filed: Aug. 1, 2023

(51) Int. Cl. B60W 50/14; B60L 53/64; H04L 67/12

(52) U.S. Cl. CPC B60W 50/14; B60L 53/64; H04L 67/12; B60W 2050/146

(57) ABSTRACT

Provided are techniques for Augmented Reality (AR) based optimization of aggregated power consumption. Digital twin simulation is performed using vehicle data to generate a plurality of possible configurations of a first vehicle and a second vehicle with AR views and to determine associated power savings. A message request to form a group and the plurality of possible configurations with the AR views and the associated power savings are sent to the second vehicle, where the AR views and the associated power savings are projected in an AR interface at the second vehicle. From the second vehicle, a message response is received approving a possible configuration of the plurality of possible configurations to form the group. The group is formed by automatically moving the first vehicle to a first position and notifying the second vehicle to move to a second position based on the approved configuration.

### BACKGROUND

Embodiments of the invention relate to Augmented Reality (AR) based optimization of aggregated power consumption.

While vehicles are moving on roadways, each of the vehicles is consuming power to drive that vehicle, and there may be various power consumption elements within the vehicle (e.g., power may be consumed by a navigation system, by windshield wipers, by lights, etc.). In some cases, the vehicles are electric vehicles, while in other cases the vehicles are gas powered and use a battery.

### SUMMARY

In accordance with certain embodiments, a computer-implemented method comprising operations is provided for AR based optimization of aggregated power consumption. In such embodiments, digital twin simulation is performed using vehicle data to generate a plurality of possible configurations of a first vehicle and a second vehicle with AR views and to determine associated power savings for each of the plurality of possible configurations. A message request to form a group and the plurality of possible configurations with the AR views and the associated power savings are sent to the second vehicle, where the AR views and the associated power savings are projected in an AR interface at the second vehicle. From the second vehicle, a message response is received approving a possible configuration of the plurality of possible configurations to form the group. The group is formed by automatically moving the first vehicle to a first position and notifying the second vehicle to move to a second position based on the approved configuration.

In accordance with other embodiments, a computer program product comprising a computer readable storage medium having program code embodied therewith is provided, where the program code is executable by at least one processor to perform operations for AR based optimization of aggregated power consumption. In such embodiments, digital twin simulation is performed using vehicle data to generate a plurality of possible configurations of a first vehicle and a second vehicle with AR views and to determine associated power savings for each of the plurality of possible configurations. A message request to form a group and the plurality of possible configurations with the AR views and the associated power savings are sent to the second vehicle, where the AR views and the associated power savings are projected in an AR interface at the second vehicle. From the second vehicle, a message response is received approving a possible configuration of the plurality of possible configurations to form the group. The group is formed by automatically moving the first vehicle to a first position and notifying the second vehicle to move to a second position based on the approved configuration.

In accordance with yet other embodiments, a computer system comprises one or more processors, one or more computer-readable memories and one or more computer-readable, tangible storage devices; and program instructions, stored on at least one of the one or more computer-readable, tangible storage devices for execution by at least one of the one or more processors via at least one of the one or more memories, to perform operations for AR-based optimization of aggregated power consumption. In such embodiments, digital twin simulation is performed using vehicle data to generate a plurality of possible configurations of a first vehicle and a second vehicle with AR views and to determine associated power savings for each of the plurality of possible configurations. A message request to form a group and the plurality of possible configurations with the AR views and the associated power savings are sent to the second vehicle, where the AR views and the associated power savings are projected in an AR interface at the second vehicle. From the second vehicle, a message response is received approving a possible configuration of the plurality of possible configurations to form the group. The group is formed by automatically moving the first vehicle to a first position and notifying the second vehicle to move to a second position based on the approved configuration.

### BRIEF DESCRIPTION OF THE SEVERAL VIEWS OF THE DRAWINGS

Referring now to the drawings in which like reference numbers represent corresponding parts throughout:

FIG. 1 illustrates, in a block diagram, a computing environment in accordance with certain embodiments.

FIG. 2 illustrates, in a block diagram, details of an Augmented Reality (AR) system code in accordance with certain embodiments.

FIG. 3 illustrates vehicles and a cloud server in accordance with certain embodiments.

FIG. 4 illustrates a train of vehicles in accordance with certain embodiments.

FIG. 5 illustrates, in a flowchart, operations for local AR-based optimization of aggregated power consumption in accordance with certain embodiments.

FIGS. 6A and 6B illustrate, in a flowchart, operations for global AR-based optimization of aggregated power consumption in accordance with certain embodiments.

FIG. 7 illustrates, in a flowchart, operations for aggregated power consumption in accordance with certain embodiments.

FIG. 8 illustrates, in a flowchart, forming a group for aggregated power consumption in accordance with certain embodiments.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as Augmented Reality (AR) system code 200. In addition to AR system code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and AR system code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

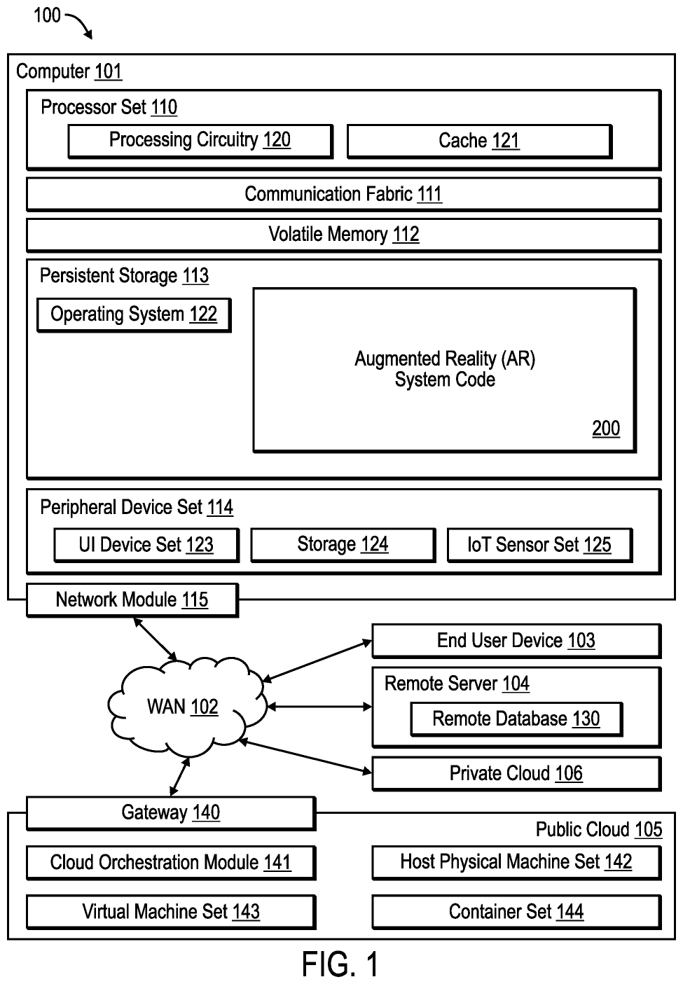

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in AR system code 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in AR system code 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

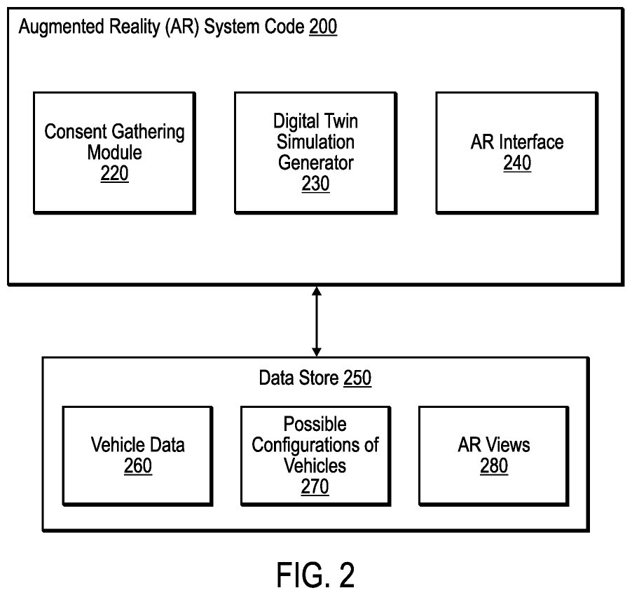

FIG. 2 illustrates, in a block diagram, details of an Augmented Reality (AR) system code 200 in accordance with certain embodiments. The AR system code 200 includes a consent gathering module 220, a digital twin simulation generator 230, and an AR interface 240. The AR system code 200 is connected to a data store 250. The data store 250 stores vehicle data 260, possible configurations of vehicles 270 (e.g., candidate configurations), and AR views 280. The vehicle data 260 includes information about vehicles, such as the specifications of the vehicles and location data to indicate which of the vehicles are close to each other.

In certain embodiments, the AR system code 200 is part of an AR headset, part of the vehicle, etc. In certain embodiments, the possible configurations of vehicles 270 are generated to optimize aggregated power consumption. In certain embodiments, a configuration identifies vehicles that may form a group and identifies a location of each of the vehicles in the group relative to each other (e.g., CarA and CarX are in a possible configuration, and CarA is behind CarX).

For every vehicle that uses power, the AR system code 200 provides an AR-based optimization by allowing the vehicles to be coupled with each other, based on consent, to improve aggregated power consumption.

While the vehicles are on the road (e.g., moving), the AR system code 200 enables the vehicles to form a group (e.g., a train) of vehicles by connecting with each other to optimize aggregated power consumption. In certain embodiments, optimizing aggregated power consumption includes the AR system code 200 of one vehicle initiating transfer of power from a battery to the battery of another vehicle.

With embodiments, the AR system code 200 enables a vehicle user (e.g., a driver, an operator, an owner, a passenger, etc.) of each vehicle to indicate consent or refusal to participate in connecting to another vehicle to optimize power consumption. For example, a vehicle user of a vehicle may want to connect to a particular vehicle, may want to keep the vehicle in a relative position (e.g., in front of the group, at the rear of the group, etc.), etc. The AR system code 200 gathers consent from individual vehicle users of the vehicles and allows them to connect to different vehicles of their choice to optimize power consumption. A position of the vehicle may be described as a physical location of the vehicle.

In certain embodiments, the consent gathering module 210 obtains consent of vehicle users to participate in a group. In certain embodiments, the consent may come from a vehicle user of the vehicle who is not driving (e.g., from a representative of a trucking company that owns a truck on the road).

In certain embodiments, the digital twin simulation generator 230 uses the vehicle data 260 to generate the possible configurations of vehicles 270 with AR views 280 and associated power savings. The AR interface 240 displays (“projects”) the AR views 280 (e.g., via an AR headset, on the windshield of the vehicle, etc.) along with the power savings for each of the possible configurations.

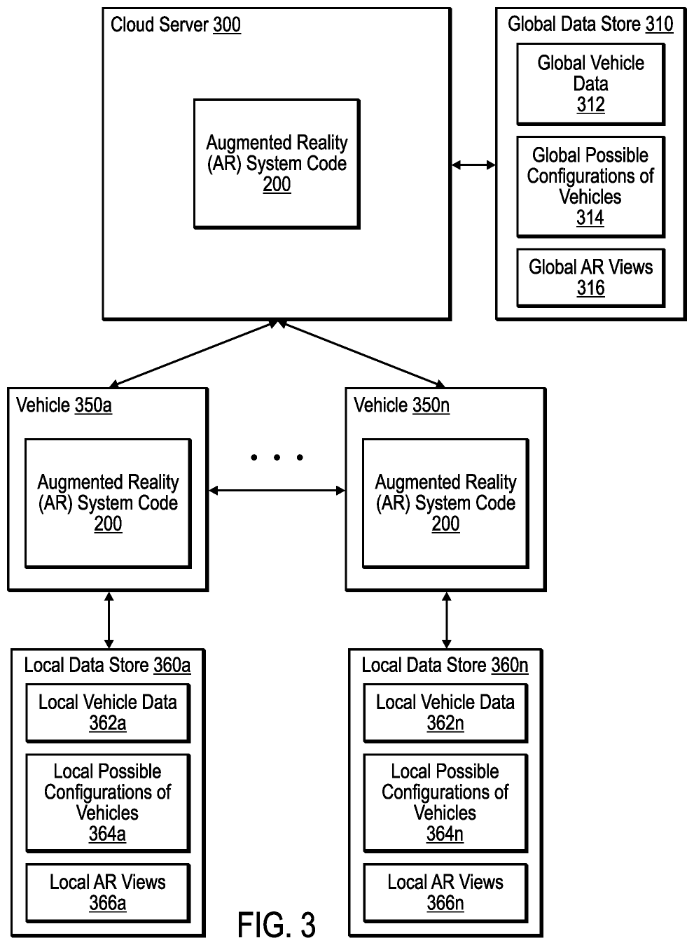

FIG. 3 illustrates vehicles and a cloud server in accordance with certain embodiments. In FIG. 3, a cloud server 300 is connected to one or more vehicles 350a . . . 350n. The cloud server 300 and each of the one or more vehicles 350a . . . 350n includes the AR system code 200.

The cloud server 300 is connected to a global data store 310 that stores global vehicle data 312, global possible configurations of vehicles 314, and global AR views 316. In certain embodiments, the AR system code 200 of the cloud server 300 may be referred to as global. The AR system code 200 of the cloud server 300 receives data from the AR system code 200 of each of the one or more vehicles 350a . . . 350n and stores the data as global vehicle data 312. Then, the AR system code 200 of the cloud server 300 may generate the global possible configurations of vehicles 314, generate and display global AR views 316 for the global possible configurations of vehicles 314, obtain consent from the vehicle users of the vehicles 350a . . . 350n to participate in a group of vehicles 350a . . . 350n (from the global possible configurations of vehicles 314 corresponding to the displayed global AR views 316), and enable optimized aggregated power consumption for the vehicles 350a . . . 350n in the group.

Each of the one or more vehicles 350a . . . 350n is connected to a local data store 360a . . . 360n. Each local data store 360a . . . 360n stores local data 362a . . . 362n, local possible configurations of vehicles 364a . . . 364n, and local AR views 366a . . . 366n. In certain embodiments, the AR system code 200 of the vehicles 350a . . . 350n are unable to connect to the cloud server 300. In such embodiments, the AR system code 200 of each of the one or more vehicles 350a . . . 350n receives data from the AR system code 200 of each of the one or more other vehicles 350a . . . 350n (e.g., within a certain distance) and stores the data as local vehicle data 362a . . . 362n. Then, the AR system code 200 of each of the vehicles 350a . . . 350n collaborate (i.e., cooperate) to generate the local possible configurations of vehicles 364a . . . 364n, generate and display local AR views 366a . . . 366n for the local possible configurations of vehicles 364a . . . 364n, obtain consent from the vehicle users of the vehicles 350a . . . 350n to participate in a group of vehicles 350a . . . 350n (from the local possible configurations of vehicles 364a . . . 364n corresponding to the displayed global AR views 366a . . . 366n), and enable optimized aggregated power consumption for the vehicles 350a . . . 350n in the group. In certain embodiments, the AR system code 200 of each of the vehicles 350a . . . 350n collaborate to designate one of the vehicles 350a . . . 350n to act as a global entity and perform the operations to enable optimized aggregated power consumption for the vehicles 350a . . . 350n in a group.

In certain embodiments, the AR system code 200 of each of the vehicles collaborate with each other to identify different possible configurations of vehicles (i.e., different groups or trains) to optimize aggregated power consumption. The AR system code 200 of each of the vehicles displays the different possible configurations of vehicles in the AR interface used by each vehicle user of each of the vehicles. The AR system code 200 generates the different possible configurations by assigning each vehicle a relative position within the group of vehicles to optimize the aggregated power consumption.

For example, Car1, Car2, and Car3 are in a group and form a train in order of Car1, Car2, and Car3. Car1 has an 80% full battery charge, Car2 has a 60% full battery charge, and Car3 has a 40% full battery charge. In this example, Car3 would like to receive a transfer of power. The AR system code 200 generates a recommended configuration of: Car1, Car3, and Car2. This allows Car3 to receive a transfer of power from both Car1 and Car2 to achieve optimized aggregated power consumption. In this example, initially, Car3 has been using 1.0% of power/hour, but in the new configuration, Car 3 is using 0.5% of power of hour, which leads to a 0.5% power savings for Car3 in the new configuration.

In certain embodiments, the AR interface 240 includes AR glass on which the AR views may be displayed and which may receive input from a vehicle user. In certain embodiments, by using the AR interface 240, the vehicle user of a vehicle may define a preferred group of vehicles in the AR glass. That is, the vehicle user of the vehicle may virtually determine how different vehicles are to be positioned to form a group of vehicles. Then, consent is obtained from the vehicle users of vehicles in the group.

Once the consent is received from different individual vehicle users of the vehicles, then the vehicles are uniquely identified (e.g., associated with unique identifiers (IDs)) and associated with a relative position. Then, the AR system code 200 of each of the vehicles collaborate to form a group of vehicles to enable optimizing aggregated power consumption.

In certain embodiments, the AR system code 200 of a first vehicle identifies each vehicle and the associated relative position on the road of each vehicle and creates an AR view so that the vehicle user of the first vehicle may select the first vehicle in the AR view and indicate a preference to couple with a second vehicle. Then, the AR system code 200 of the second vehicle may approve (i.e., consent to or accept) or reject (i.e., not consent to) the request based on vehicle user input and other factors (e.g., compatibility of vehicles for sharing power). An AR view may be described as a 3 dimensional (3D) representation of the vehicles and the world around the vehicles at a point in time (e.g., the vehicles, the road, buildings, plants, etc.). In certain embodiments, the AR view is created for each possible configuration of vehicles. That is, the AR view displays the vehicles and their surroundings.

In certain embodiments, the AR system code 200 allows groups of vehicles to be designated in advance (i.e., pre-formed groups), with consent of vehicle users (e.g., family members may form a group, friends may form a group, work colleagues traveling in a same direction may form a group, etc.) to share power. The pre-formed groups may be designated as having automatic consent. This allows for remembered vehicles and pre-approved vehicles based on attributes to form a group. Examples of attributes include: the type of vehicle, vehicles of a family member, friend, someone from a social network, or purpose of the power (e.g., a vehicle user consents in advance to transfer power to an ambulance). Each vehicle user may update preferences and/or withdraw from the pre-formed group. In such embodiments, the AR system code 200 may store a user profile for each vehicle user or for each vehicle to store the attributes for the pre-formed groups.

In certain embodiments, the AR system code 200 uses digital twin simulation to identify possible configurations of vehicles for forming a group of vehicles to optimize aggregated power consumption based on compatibility, which is based on any combination of: vehicle specifications, types of vehicles, battery capacity of the vehicles, destinations of the vehicles, whether vehicles are transporting items (e.g., oil or milk), etc. In addition, with digital twin simulation, the AR system code 200 determines how much power savings may be obtained for each of the possible configurations of vehicles. A digital twin simulation may be described as using a virtual model (e.g., 3D vehicles in an AR view) to reflect a physical object (the vehicles on the road). The AR system code 200 uses digital twin simulation to create AR views for possible configurations of vehicles (e.g., by generating simulations using data and what-if scenarios) and to determine power savings for each of the configurations. Then, for each of the possible configurations, the AR system code 200 displays (“projects”) an AR view and the associated power savings, via an AR interface, for each vehicle user of the vehicles in each group to enable each vehicle user to select and/or modify a configuration of the possible configurations. In certain embodiments, the AR system code 200 recommends the possible configuration of vehicles with the most power savings. In certain embodiments, the number of possible configurations to be presented to the vehicle user may be pre-determined (e.g., to avoid overloading the vehicle user with too many options or with options that are not efficient for power savings). In certain embodiments, the AR system code 200 recommends the possible configurations of vehicles whose associated power savings exceeds a threshold.

In certain embodiments, the AR system code 200 receives consent for a particular group of the possible configurations and creates a relationship between the vehicles in the group to enable optimized aggregated power consumption.

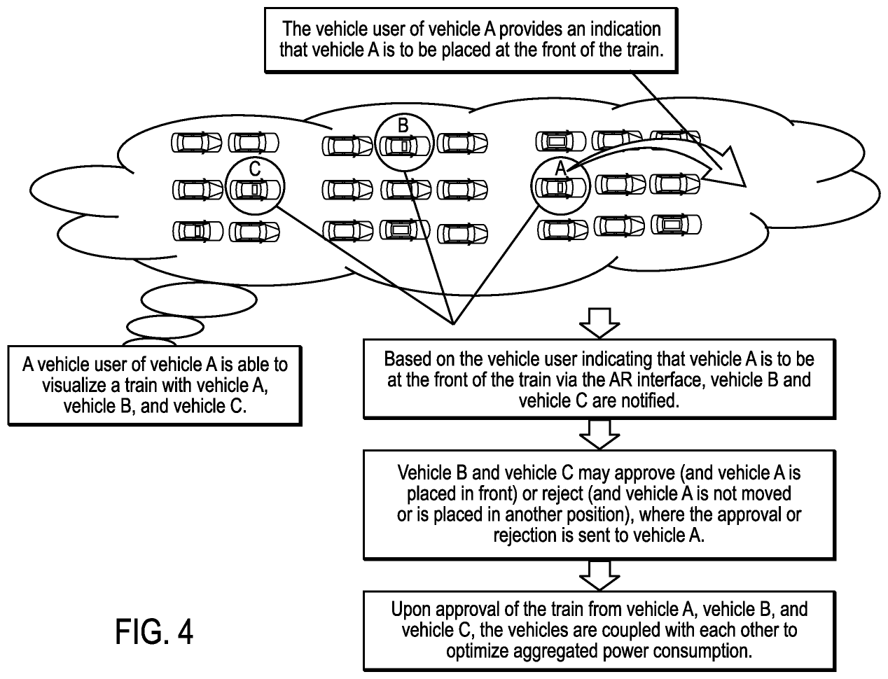

FIG. 4 illustrates a train (e.g., a type of group) of vehicles in accordance with certain embodiments. In FIG. 4, the AR system code 200 of vehicles A, B, and C collaborate to form a train and consent to share power with each other. Initially, the AR system code 200 of vehicle A displays an AR view in an AR interface of vehicle A to show how various vehicles may be configured to create a train of vehicles. In addition, the AR system code 200 of vehicle A may receive input from a vehicle user indicating a position of vehicle A in the train relative to vehicle B and/or vehicle C (e.g., a position in front, behind or next to). Then, the AR system code 200 of each of vehicle B and of vehicle C may provide consent to participate in the train or may reject participation in the train. If the AR system code 200 of vehicle B and of vehicle C approve the position of vehicle A, the AR system code 200 of vehicle A moves vehicle A to that position. If the AR system code 200 of vehicle B and of vehicle C reject the position of vehicle A, the AR system code 200 of vehicle A may not move vehicle A or may move vehicle A to another position.

In some embodiments, if the AR system code 200 of vehicle A provides an indication of position in the train, and the AR system code 200 of vehicle B and/or vehicle C rejects this, and the AR system code 200 of each of vehicle A, vehicle B, and vehicle C may go back and forth until agreement is reached on positions. Once the AR system code 200 of each of vehicle A, vehicle B, and vehicle C receive consent on a particular configuration, the AR system code 200 of each of vehicle A, vehicle B, and vehicle C collaborate to optimize aggregated power consumption for maximizing power savings.

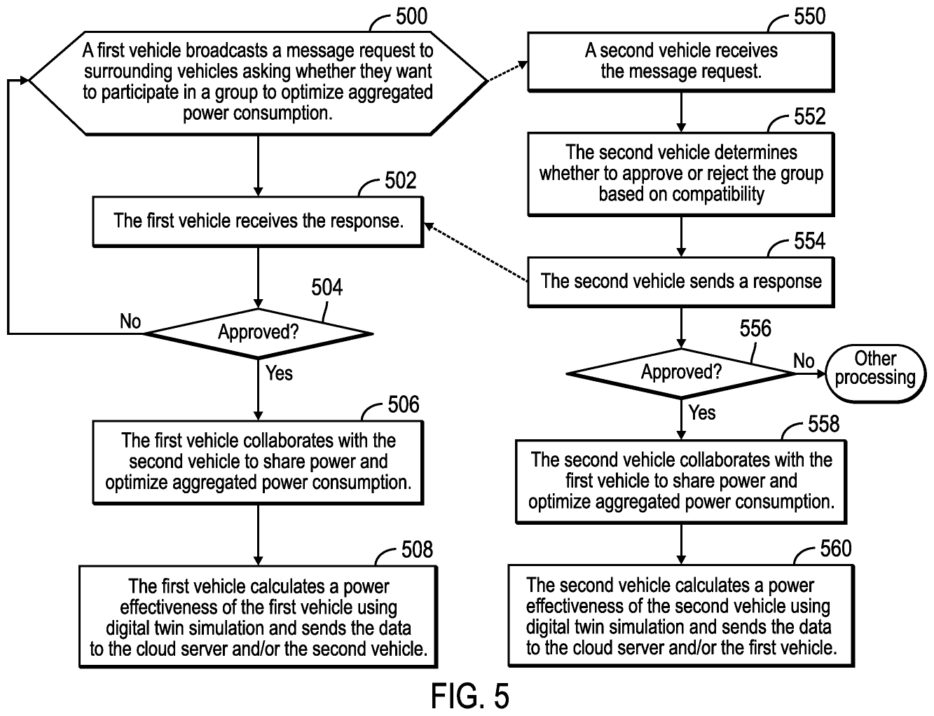

FIG. 5 illustrates, in a flowchart, operations for local AR-based optimization of aggregated power consumption in accordance with certain embodiments. Control begins at block 500 with the AR system code 200 of a first vehicle broadcasting a message request to surrounding vehicles asking whether they want to participate in a group to optimize aggregated power consumption. In certain embodiments, the AR system code 200 of the first vehicle broadcasts the message request in response to a determination that the battery power is low. In other embodiments, the AR system code 200 of the first vehicle broadcasts the message request in response to input from the vehicle user of the first vehicle. In certain embodiments, the message request is broadcast to vehicles within a pre-determined distance of the first vehicle.

In block 550, the AR system code 200 of a second vehicle receives the message request. In block 552, the AR system code 200 of the second vehicle determines whether to approve or reject the group. In certain embodiments, the approval or rejection is based on compatibility of the first and second vehicles. In block 554, the AR system code 200 of the second vehicle sends a response.

In block 502, the AR system code 200 of the first vehicle receives the response from the AR system code 200 of the second vehicle. In block 504, the AR system code 200 of the first vehicle determines whether the response indicates approval by the AR system code 200 of the second vehicle. If so, processing continues to block 506, otherwise, processing continues to block 500 (e.g., to resend the message request in case no other vehicle approved as the vehicles in the vicinity may change at any point in time).

In block 506, the AR system code 200 of the first vehicle collaborates with the AR system code 200 of the second vehicle to share power and optimize aggregated power consumption. In block 508, the AR system code 200 of the first vehicle calculates a power effectiveness of the first vehicle using digital twin simulation and sends the data to the cloud server and/or the second vehicle. In certain embodiments, the data includes information about the vehicles in the group, the power effectiveness, etc. Power effectiveness may be described as how effectively a single vehicle may use the power that the vehicle has. For example, if the vehicle is using high beam that consumes power, then the vehicle may want to turn off high beams for more effective use of power.

In block 556, the AR system code 200 of the second vehicle determines whether the response indicates approval. If so, processing continues to block 558, otherwise, processing continues to other processing (e.g., waiting until another message request is received or a message request is to be initiated).

In block 558, the AR system code 200 of the second vehicle collaborates with the first vehicle to share power and optimize aggregated power consumption. In block 560, the AR system code 200 of the second vehicle calculates a power effectiveness of the second vehicle using digital twin simulation and sends the data to the cloud server and/or the first vehicle.

In certain embodiments, the processing of blocks 504-508 and blocks 556-560 may occur in parallel.

In certain embodiments, while the vehicles are on the road, the AR system code 200 of each vehicle recognizes the AR system code 200 of each other vehicle and shares the specification of the vehicle. In certain embodiments, the specification of a vehicle may describe power generation, self and payload, and additional details of the vehicle.

In certain embodiments, the AR system code 200 of each vehicle generates a digital twin model to identify power effectiveness of that vehicle. In particular, the AR system code 200 of each vehicle performs digital twin simulation of the vehicle-to-vehicle relative positions to calculate the power effectiveness. Based on the power effectiveness, the AR system code 200 of each vehicle may make modifications (e.g., turning off air conditioning to save power that may be transferred to another vehicle).

The AR system code 200 of each vehicle may recommend that the vehicles change positions to be more effective in the collaboration for optimized aggregated power consumption (e.g., if the first vehicle is in front of the second vehicle, the recommendation may be for the second vehicle to be in front of the first vehicle).

In certain embodiments, the AR system code 200 of each vehicle identifies every other vehicle within a particular vicinity, the specification of that vehicle, the relative position on the road of that vehicle, etc., and creates a 3D model of the vehicles on the road.

In certain embodiments, the AR system code 200 of each vehicle identifies different possible configurations of vehicles that may be arranged in a lane (e.g., of a roadway having one or more lanes) and be connected (e.g., in particular physical positions such that they are able to perform wireless power transfer) to create a train of vehicles that share power so that aggregated power consumption is optimized. In certain embodiments, the AR system code 200 of each vehicle identifies possible configurations of vehicles that may be arranged in a group and physically be connected to create a group of vehicles that share power so that aggregated power consumption is optimized.

In certain embodiments, the AR system code 200 of each vehicle identifies the destination of different vehicles and how the vehicles may be coupled with each other for at least a part of the way to the destination (e.g., if one vehicle is going north 100 miles and another vehicle is going north 50 miles, then the vehicles may be coupled for 50 miles).

In certain embodiments, the AR system code 200 of each vehicle creates a connection (e.g., a wireless connection) relative to the current positions of the vehicles and how the vehicles are to be arranged physically (i.e., in particular physical locations) to optimize the power consumption.

In certain embodiments, the AR system code 200 of each vehicle has AR capability, either with the vehicle windscreen, vehicle display or with a head mounted AR device.

In certain embodiments, the AR system code 200 of each vehicle displays, in the AR content, the current vehicle so that the vehicle user may take appropriate action, such as to approve a group, reject the group, modify the group (e.g., change the position of the vehicle), etc.

In certain embodiments, the AR system code 200 of each vehicle also displays, in the AR content, the possible configurations of groups of vehicles (e.g., trains) creation to optimize the aggregated power consumption.

In certain embodiments, the AR system code 200 of each vehicle enables the respective vehicle users to adjust the position of the vehicles form the group of vehicles train and/or indicate approval or rejection of the group.

In certain embodiments, the AR system code 200 of each vehicle enables each respective vehicle user to define how vehicle train or group is to be created so that the aggregated power consumption is optimized.

In certain embodiments, while creating a vehicle user defined train or group of vehicles, the AR system code 200 of a first vehicle enables the vehicle user to send a message request to the AR system code 200 of a second vehicle with the AR interface. The second vehicle may respond with approval or rejection of the message request.

In certain embodiments, the AR system code 200 of each vehicle determines whether the vehicles are compatible to perform vehicle to vehicle physical coupling.

In certain embodiment, the vehicles are physically coupled based on the received consent from respective vehicles and collaborate to optimize aggregated power consumption.

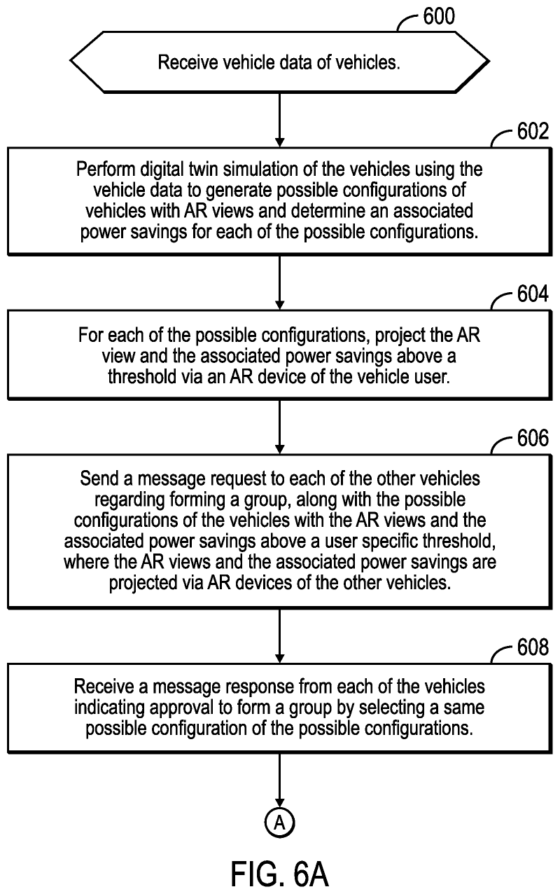

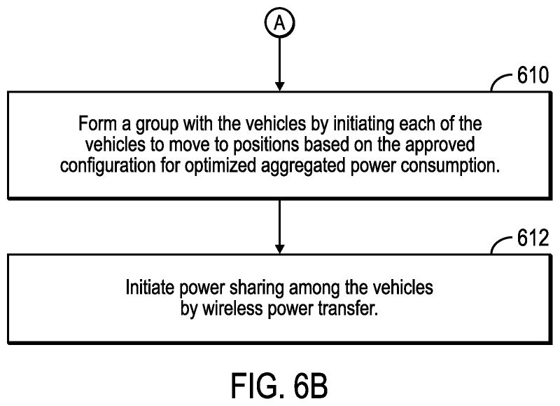

FIGS. 6A and 6B illustrate, in a flowchart, operations for global AR-based optimization of aggregated power consumption in accordance with certain embodiments. In certain embodiments, the AR system code 200 performs the operations of FIGS. 6A and 6B at the cloud server 300, while, in other embodiments, the AR system code 200 performs the operations of FIGS. 6A and 6B at a vehicle 350a . . . 350n.

Control begins at block 600 with the AR system code 200 receiving vehicle data of vehicles. In certain embodiments, receiving vehicle data means retrieving vehicle data that had been previously received. In certain embodiments, the vehicle data is received for vehicles within a predetermined area (e.g., within a predetermined distance from each other).

In block 602, the AR system code 200 performs digital twin simulation of the vehicles using the vehicle data to generate possible configurations of vehicles with AR views and determine an associated power savings (for one or more vehicles) for each of the possible configurations. In certain embodiments, the possible configurations are based on compatibility of the vehicles. The compatibility may be based on any combination of: vehicle specifications, types of vehicles, battery capacity of the vehicles, destinations of the vehicles, whether vehicles are transporting items (e.g., oil or milk), etc. Each possible configuration is associated with an AR view and with an associated power savings.

In block 604, for each of the possible configurations, the AR system code 200 projects the AR view and the associated power savings above a threshold (e.g., a vehicle user specified threshold) via an AR device of the vehicle user. In certain embodiments, the AR view and the associated power savings for each of the possible configurations are displayed one at a time to allow for selection. In other embodiments, the AR view and the associated power savings for each of the possible configurations are displayed are displayed together to allow for selection.

In block 606, the AR system code 200 sends a message request to each of the other vehicles regarding forming a group, along with the possible configurations of the vehicles with the AR views and the associated power savings above a user specific threshold, where the AR views and the associated power savings are projected via AR devices of the other vehicles

In block 608, the AR system code 200 receives a message response from each of the vehicles indicating approval to form a group by selecting a same possible configuration of the possible configurations. From block 608 (FIG. 6A), processing continues to block 610 (FIG. 6B).

In block 610, the AR system code 200 forms a group with the vehicles by initiating each of the vehicles to move to positions based on the approved configuration for optimized aggregated power consumption. In block 612, the AR system code 200 initiates power sharing among the vehicles by wireless power transfer.

In certain embodiments, if acceptance is not received for a same configuration by all vehicles in the group, the AR system code 200 may form other configurations to send, may form the group with the subset of vehicles that accepted the same group, etc.

In certain embodiments, the AR system code 200 sends multiple possible configurations to the vehicle users for selection. For example, the multiple possible configurations may be all of the configurations, the configurations with the highest power savings, a pre-determined (e.g., by a system administrator or by a vehicle user) number of configurations, etc. In certain other embodiments, the AR system code 200 selects a first configuration from the possible configurations to form a group of vehicles to aggregate power consumption, generates a first AR view for the first configuration, and sends a message request to form a group with the first AR view. Then, if the vehicle users for vehicles in the group do not approve this group, the AR system code 200 selects a second configuration, generates a second AR view for the second configuration, and sends another message to form a group with the second AR view. The AR system code 200 may continue selecting and processing each of the possible configurations in this manner until an AR view associated with a selected configuration is approved by the vehicle users in the group.

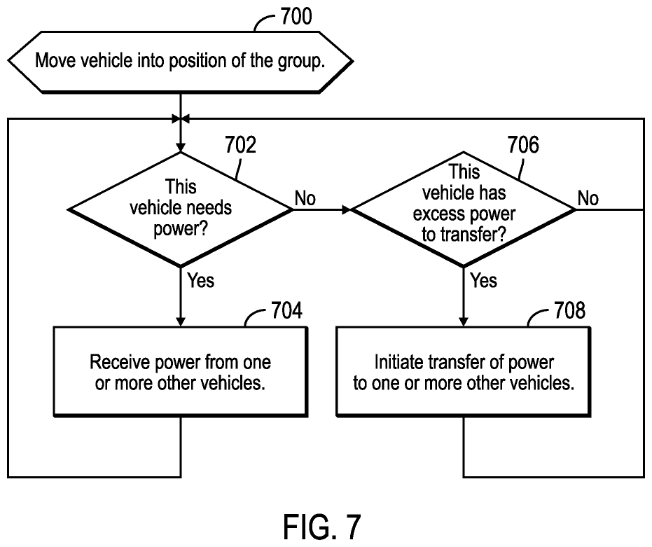

FIG. 7 illustrates, in a flowchart, operations for aggregated power consumption in accordance with certain embodiments. The operations of FIG. 7 may occur at each of the vehicles that form the group of vehicles. Control begins at block 700 with the AR system code 200 moving the vehicle into a position of the group, where the position of the vehicle was approved when the group was being formed. In block 702, the AR system code 200 determines whether this vehicle needs power. If so processing continues to block 704, otherwise, processing continues to block 706. In block 704, the battery of the vehicle receives power from one or more other vehicles in the group. From block 704, processing continues to block 702.

In block 706, the AR system code 200 determines whether the vehicle has excess power to transfer. If so, processing continues to block 708, otherwise, processing continues to block 702. In block 708, the AR system code 200 initiates transfer of power to one or more other vehicles in the group and the power. With such initiation, power is transferred from the battery of the vehicle in the group to the battery of another vehicle in the group. From block 708, processing continues to block 702.

In certain embodiments, wireless power transfer is used to transfer power between vehicles. This allows the transmission of electrical energy without a physical connection. For example, radio-frequency (RF) technologies may be used for wireless power transmission.

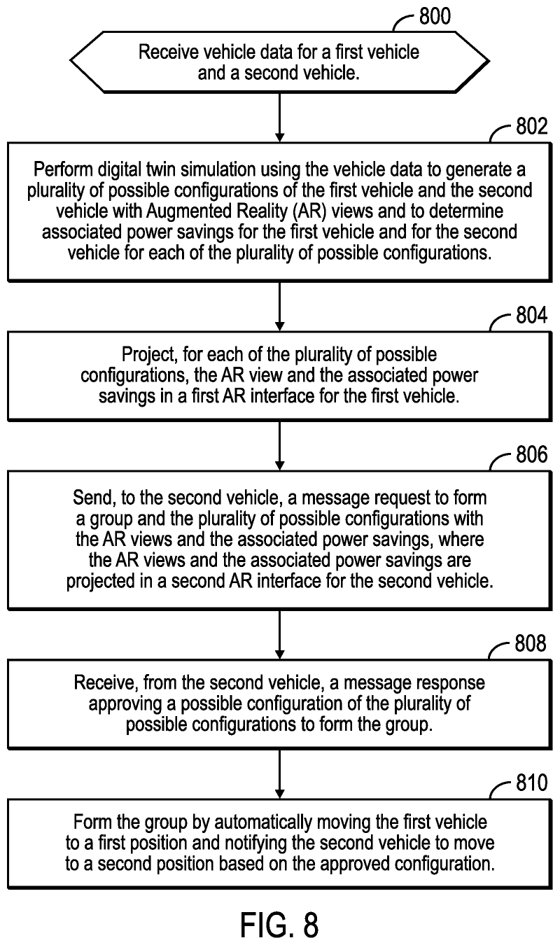

FIG. 8 illustrates, in a flowchart, forming a group for aggregated power consumption in accordance with certain embodiments. Control begins at block 800 with the AR system code 200 receiving vehicle data for a first vehicle and a second vehicle. In block 802, the AR system code 200 performs digital twin simulation using the vehicle data to generate a plurality of possible configurations of the first vehicle and the second vehicle with AR views and to determine associated power savings for the first vehicle and for the second vehicle for each of the plurality of possible configurations.

In block 804, the AR system code 200 projects, for each of the plurality of possible configurations, the AR view and the associated power savings for the first vehicle (and optionally the power savings of the second vehicle) in a first AR interface for the first vehicle. In block 806, the AR system code 200 sends, to the second vehicle, a message request to form a group and the plurality of possible configurations with the AR views and the associated power savings of the second vehicle (and optionally the power savings of the first vehicle), where the AR views and the associated power savings are projected in a second AR interface for the second vehicle.

In block 808, the AR system code 200 receives, from the second vehicle, a message response approving a possible configuration of the plurality of possible configurations to form the group. This approval indicates consent by a vehicle user of the second vehicle to form the group for power sharing. In certain embodiments, the vehicle user at the second vehicle selects an AR view corresponding to a possible configuration using the AR interface at the second vehicle. In block 810, the AR system code 200 forms the group by automatically moving the first vehicle to a first position and notifying the second vehicle to move to a second position based on the approved configuration.

In certain embodiments, transfer of power is initiated between the first vehicle and the second vehicle to optimize aggregated power consumption.

In certain embodiments, instructions are received, via the AR interface at the second vehicle, to change a position of the second vehicle in the approved configuration. Then, in response to receiving consent, via another AR interface at the first vehicle, to the changing of the position of the second vehicle, the approved configuration is revised to update the position of the first vehicle and the position of the second vehicle.

In certain embodiments, the first vehicle and the second vehicle communicate with each other using a cloud server. In such embodiments, the cloud server may perform digital twin simulation using the vehicle data to generate a plurality of possible configurations of the first vehicle and the second vehicle with AR views and to determine associated power savings for each of the plurality of possible configurations.

In certain embodiments, a third vehicle and a fourth vehicle are part of a pre-formed group.

In certain embodiments, the AR system code 200 forms a train of vehicles for a first vehicle running on a road and a second vehicle running on the road. The AR system code 200 of the first vehicle and the AR system code 200 of the second vehicle communicate with each other to identify different possibilities of forming a train of vehicles to optimize aggregated power consumption. The AR system code 200 of the first vehicle displays the different possibilities in an AR interface to a vehicle user of the first vehicle. The AR system code 200 of the second vehicle displays the different possibilities in an AR interface to a vehicle user of the second vehicle.

In certain embodiments, the AR system code 200 of the first vehicle receives, from a vehicle user of the first vehicle using the AR interface, an indication of how the first vehicle is to be grouped (e.g., coupled) with the second vehicle in the train. In such embodiments, the AR system code 200 of the second vehicle receives, from a vehicle user of the second vehicle using the AR interface, an indication of how the first vehicle is to be grouped with the second vehicle in the train. If both vehicle users indicate the same group (e.g., the first vehicle is in front of the second vehicle), then the AR system code 200 of the first vehicle and the AR system code 200 of the second vehicle deem this to be consent for that group.

In certain embodiments, once consent is received from different individual vehicle users of the vehicles, then the AR system code 200 of the first and second vehicles associate the first and second vehicles with unique IDs and relative positions in the group. The AR system code 200 of the first and second vehicles collaborate with each other to form a train of vehicles and optimize the power consumption.

In certain embodiments, the AR system code 200 at the cloud server 300 or at one vehicle identifies every vehicle and a relative position of that vehicle on the road and creates an AR view so that the vehicle user of the first vehicle may select the first vehicle in the AR view and identify a group, while the vehicle user of the second vehicle may select the second vehicle in the AR view and identify a group.

In certain embodiments, the AR system code 200 of the first vehicle and the AR system code 200 of the second vehicle determine possible groups based on compatibility of the first vehicle and the second vehicle. The compatibility may be based on any combination of: vehicle specifications of the first vehicle and the second vehicle, types of the first vehicle and the second vehicle (e.g., sedan or truck), battery capacity of the first vehicle and the second vehicle, destinations of the first vehicle and the second vehicle, whether the first vehicle and the second vehicle are transporting items (e.g., oil or milk), etc.

Then, the AR system code 200 of the first vehicle and the AR system code 200 of the second vehicle identify how much power savings there would be for each of the possible groups.

In certain embodiments, the AR system code 200 may use data from Internet of Things (IoT) devices. The AR system code 200 leverages an AR interface to allow a vehicle user to select one or more vehicles out of a recommended possible configuration of vehicles to connect with to form a vehicle group for optimizing the aggregated power consumption by the group of connected vehicles. With embodiments, the AR interface displays different possible configurations of forming the vehicle group and the corresponding power savings to the vehicle user, and the vehicle user makes a selection of vehicles to connect with via the AR interface. The AR system code 200 identifies an appropriate sequence of vehicles or relative positions of the vehicles that makes the power consumption optimized.

The AR system code 200 prompts the vehicle user of one vehicle to select how to couple with another vehicle based on a configuration represented using an AR view and facilitates coordination of the vehicles by autonomously operating each vehicle uniquely based on the relative position of each vehicle so that each vehicle collaborates with each other to form a train or group of vehicles and optimize the power consumption. In certain other embodiments, the AR system code 200 issues driving instructions to each vehicle user based on the relative position of each vehicle so that each vehicle collaborates with each other to form a train or group of vehicles and optimize the power consumption.

The AR system code 200 may also create an AR boundary for the group of vehicles (for which consent has been approved), and, within the AR boundary, the AR system code 200 allows the vehicle users to add/remove vehicles collectively and facilitates collaboration or resource sharing (e.g., computing power) between the vehicles.

In certain embodiments, the AR system code 200 forms a train of vehicles with a first vehicle and a second vehicle communicating with each other to identify different possibilities of forming a train of vehicles to optimize aggregated power consumption. The AR system code 200 displays, through a digital display, the different possibilities of forming a train of vehicles to optimize aggregated power consumption, where the digital display is an AR interface in each of the first and second vehicles.

In certain embodiments, the AR system code 200 receives, by the AR interface, instructions or parameters as to how the first vehicle couples with the second vehicle. In certain embodiments, the AR system code 200 receives, by the AR interface, instructions or parameters on how different vehicles will be positioned to form the train of vehicles.

In certain embodiments, responsive to receiving consent from a plurality of vehicle users, the In certain embodiments, the AR system code 200 receives, by the AR interface, uniquely identifies a relative position of each vehicle associated with the plurality of vehicle users, facilitates coordination of the vehicles by issuing driving instructions to each vehicle user or autonomously operating each vehicle uniquely based on the relative position of each vehicle so that each vehicle collaborates with each other to form a train of vehicle and to optimize the power consumption.

In certain embodiments, the AR system code 200 creates at least one AR configuration of surrounding vehicles and proposed train configurations and prompts the vehicle user of the first vehicle to select how to couple with the second vehicle based on the at least one AR configuration.

In certain embodiments, the AR system code 200 identifies, using digital twin simulation, various possibilities of forming the vehicle train based on vehicle specification, types of vehicles, and battery capacity of the vehicles. Then, the AR system code 200 generates and displays, using digital twin simulation, AR views based on the identified various possibilities. In addition, the AR system code 200 identifies, using digital twin simulation, a power saving configuration of the train of vehicles.

In certain embodiments, the first vehicle and second vehicle are each concurrently operating. In certain embodiments, the vehicles are automotive vehicles (e.g., cars, trucks, buses, etc.) that move on a roadway (e.g., street, highway, freeway, etc.).

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

In the described embodiment, variables a, b, c, i, n, m, p, r, etc., when used with different elements may denote a same or different instance of that element.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, embodiments of the invention reside in the claims herein after appended. The foregoing description provides examples of embodiments of the invention, and variations and substitutions may be made in other embodiments.

What is claimed is:

1. A computer-implemented method, comprising operations for:
performing digital twin simulation using vehicle data to generate a plurality of possible configurations of a first vehicle and a second vehicle with Augmented Reality (AR) views and to determine associated power savings for each of the plurality of possible configurations;
sending, to the second vehicle, a message request to form a group and the plurality of possible configurations with the AR views and the associated power savings, wherein the AR views and the associated power savings are projected in an AR interface at the second vehicle;
receiving, from the second vehicle, a message response approving a possible configuration of the plurality of possible configurations to form the group; and
forming the group by automatically moving the first vehicle to a first position and notifying the second vehicle to move to a second position based on the approved configuration.

2. The computer-implemented method of claim 1, further comprising:
initiating transfer of power between the first vehicle and the second vehicle to optimize aggregated power consumption.

3. The computer-implemented method of claim 1, further comprising:
receiving instructions, via the AR interface at the second vehicle, changing a position of the second vehicle in the approved configuration; and
in response to receiving consent, via another AR interface at the first vehicle, to the changing of the position of the second vehicle, revising the approved configuration to update the position of the first vehicle and the position of the second vehicle.

4. The computer-implemented method of claim 1, wherein the plurality of possible configurations of vehicles are generated to optimize aggregated power consumption based on compatibility.

5. The computer-implemented method of claim 4, wherein the compatibility is based on any combination of: vehicle specifications of the first vehicle and the second vehicle, types of the first vehicle and the second vehicle, capacity of the first vehicle and the second vehicle, destinations of the first vehicle and the second vehicle, and whether the first vehicle and the second vehicle are transporting items.

6. The computer-implemented method of claim 1, wherein the first vehicle and the second vehicle communicate with each other using a cloud server.

7. The computer-implemented method of claim 1, wherein a third vehicle and a fourth vehicle are part of a pre-formed group.

8. A computer program product, the computer program product comprising a computer readable storage medium having program instructions embodied therewith, the program instructions executable by a processor to cause the processor to perform operations for:
performing digital twin simulation using vehicle data to generate a plurality of possible configurations of a first vehicle and a second vehicle with Augmented Reality (AR) views and to determine associated power savings for each of the plurality of possible configurations;
sending, to the second vehicle, a message request to form a group and the plurality of possible configurations with the AR views and the associated power savings, wherein the AR views and the associated power savings are projected in an AR interface at the second vehicle;
receiving, from the second vehicle, a message response approving a possible configuration of the plurality of possible configurations to form the group; and
forming the group by automatically moving the first vehicle to a first position and notifying the second vehicle to move to a second position based on the approved configuration.

9. The computer program product of claim 8, wherein the program instructions are executable by the processor to cause the processor to further perform operations for:
initiating transfer of power between the first vehicle and the second vehicle to optimize aggregated power consumption.

10. The computer program product of claim 8, wherein the program instructions are executable by the processor to cause the processor to further perform operations for:
receiving instructions, via the AR interface at the second vehicle, changing a position of the second vehicle in the approved configuration; and
in response to receiving consent, via another AR interface at the first vehicle, to the changing of the position of the second vehicle, revising the approved configuration to update the position of the first vehicle and the position of the second vehicle.

11. The computer program product of claim 8, wherein the plurality of possible configurations of vehicles are generated to optimize aggregated power consumption based on compatibility.

12. The computer program product of claim 11, wherein the compatibility is based on any combination of: vehicle specifications of the first vehicle and the second vehicle, types of the first vehicle and the second vehicle, capacity of the first vehicle and the second vehicle, destinations of the first vehicle and the second vehicle, and whether the first vehicle and the second vehicle are transporting items.

13. The computer program product of claim 8, wherein the first vehicle and the second vehicle communicate with each other using a cloud server.

14. The computer program product of claim 8, wherein a third vehicle and a fourth vehicle are part of a pre-formed group.

15. A computer system, comprising:
one or more processors, one or more computer-readable memories and one or more computer-readable, tangible storage devices; and
program instructions, stored on at least one of the one or more computer-readable, tangible storage devices for execution by at least one of the one or more processors via at least one of the one or more computer-readable memories, to perform operations comprising:
performing digital twin simulation using vehicle data to generate a plurality of possible configurations of a first vehicle and a second vehicle with Augmented Reality (AR) views and to determine associated power savings for each of the plurality of possible configurations;
sending, to the second vehicle, a message request to form a group and the plurality of possible configurations with the AR views and the associated power savings, wherein the AR views and the associated power savings are projected in an AR interface at the second vehicle;
receiving, from the second vehicle, a message response approving a possible configuration of the plurality of possible configurations to form the group; and
forming the group by automatically moving the first vehicle to a first position and notifying the second vehicle to move to a second position based on the approved configuration.

16. The computer system of claim 15, wherein the program instructions further perform operations comprising:
initiating transfer of power between the first vehicle and the second vehicle to optimize aggregated power consumption.

17. The computer system of claim 15, wherein the program instructions further perform operations comprising:
receiving instructions, via the AR interface at the second vehicle, changing a position of the second vehicle in the approved configuration; and
in response to receiving consent, via another AR interface at the first vehicle, to the changing of the position of the second vehicle, revising the approved configuration to update the position of the first vehicle and the position of the second vehicle.

18. The computer system of claim 15, wherein the plurality of possible configurations of vehicles are generated to optimize aggregated power consumption based on compatibility.

19. The computer system of claim 18, wherein the compatibility is based on any combination of: vehicle specifications of the first vehicle and the second vehicle, types of the first vehicle and the second vehicle, capacity of the first vehicle and the second vehicle, destinations of the first vehicle and the second vehicle, and whether the first vehicle and the second vehicle are transporting items.

20. The computer system of claim 15, wherein the first vehicle and the second vehicle communicate with each other using a cloud server.
